(19) United States
(12) Patent Application Publication
(10) Pub. No.: US 2016/0222729 A1
(43) Pub. Date: Aug. 4, 2016

(54) Stepladder Having Tipping Prevention Function

(71) Applicant: Chang-I Shih, Tainan City (TW)

(72) Inventor: Chang-I Shih, Tainan City (TW)

(21) Appl. No.: 14/609,931

(22) Filed: Jan. 30, 2015

(51) Int. Cl. E06C 1/383; E06C 7/14; E06C 7/42

(52) U.S. Cl. CPC E06C 1/383; E06C 7/42; E06C 7/14

(57) ABSTRACT

A stepladder includes two frames pivotally connected with each other, two pairs of support levers pivotally connected with the two frames, and two pairs of links pivotally connected with the two frames and pivotally connected with the support levers. Each of the two frames is provided with a side bar which has a first end formed with a connecting portion and a second end formed with a working portion. The working portion of the side bar is provided with a hook. Thus, each of the support levers is expanded and placed on the ground, and each of the links is connected between each of the support levers and each of the two frames in an inclined manner, so that the two frames are supported so as to prevent the stepladder from tipping or falling down.

### BACKGROUND OF THE INVENTION

1. Field of the Invention

The present invention relates to a ladder and, more particularly, to a stepladder.

2. Description of the Related Art

A conventional stepladder comprises two frames pivotally connected with each other at upper ends thereof, and two opposite linkages pivotally connected between the two frames to fix the two frames so as to prevent the angle between the two frames from being changed when in use. However, the lower end of each of the two frames is not supported solidly and stably, so that the two frames easily tip or fall down when the user is disposed at an inclined situation or when the two frames are placed on an uneven ground. In addition, the stepladder is not provided with any upright support structure so that the user cannot stand and work on the top of the stepladder. Further, the stepladder is not provided with any hanger for hanging the user's tool bag, thereby causing inconvenience to the user.

### BRIEF SUMMARY OF THE INVENTION

The primary objective of the present invention is to provide a stepladder having a tipping prevention function.

In accordance with the present invention, there is provided a stepladder comprising two frames pivotally connected with each other, two pairs of support levers pivotally connected with the two frames, and two pairs of links pivotally connected with the two frames and pivotally connected with the support levers.

The stepladder further comprises two pairs of positioning members connected with the links. Each of the two frames is formed with a plurality of fixing holes. Each of the links has a first end pivotally connected with a mediate portion of each of the support levers. Each of the positioning members extends through a second end of each of the links and is positioned in one of the fixing holes of each of the two frames, so that each of the links is connected with each of the two frames.

Each of the two frames is provided with a side bar which has a first end formed with a connecting portion and a second end formed with a working portion.

The working portion of the side bar is provided with a hook.

Each of the two frames is provided with an upper retaining seat for holding the side bar and a lower retaining seat for holding the side bar.

Each of the support levers is pivotally connected between each of the two frames and each of the links. Each of the two frames is formed with two elongate slots. Each of the support levers has a first end pivotally connected with each of the links and a second end pivotally and movably mounted in one of the two elongate slots of each of the two frames. Each of the links has an upper end pivotally connected with each of the two frames and a lower end provided with a threaded rod which is connected with a threaded stand.

Each of the two frames is formed with a slideway to allow a sliding motion of the connecting portion of the side bar. The slideway of each of the two frames has two ends each formed with a limit hole to limit the connecting portion of the side bar. Thus, the working portion of the side bar is constantly directed upward and protrudes outward from the top of the stepladder.

Each of the two frames is provided with at least one foot board which has an interior provided with two extension brackets. Each of the extension brackets has a substantially L-shaped structure and has a transverse section extending into the interior of the foot board of each of the two frames and an upright section provided with a threaded rod which is connected with a threaded leg.

Each of the support levers has a substantially L-shaped profile and is located at a lower end of each of the two frames.

According to the primary advantage of the present invention, each of the support levers is expanded and placed on the ground, and each of the links is connected between each of the support levers and each of the two frames in an inclined manner, so that the two frames are supported solidly and stably so as to enhance solidity and stability of the stepladder and to prevent the stepladder from tipping or falling down, thereby protecting the user's safety.

According to another advantage of the present invention, the side bar is expanded to protrude upward from each of the two frames, so that the user can hold the side bar when standing on the two frames, thereby enhancing the user's safety.

According to a further advantage of the present invention, the side bar is provided with a hook to hang the user's tool bag when the user stands highly on the two frames.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a stepladder in accordance with the preferred embodiment of the present invention.

FIG. 2 is a schematic operational view of the stepladder as shown in FIG. 1.

FIG. 3 is a side view of the stepladder as shown in FIG. 1.

FIG. 4 is a schematic operational view of the stepladder as shown in FIG. 3.

FIG. 5 is a schematic operational view of the stepladder as shown in FIG. 4.

FIG. 6 is a side view of a stepladder in accordance with another preferred embodiment of the present invention.

FIG. 7 is a schematic operational view of the stepladder as shown in FIG. 6.

FIG. 8 is a perspective view of a stepladder in accordance with another preferred embodiment of the present invention.

FIG. 9 is a schematic operational view of the stepladder as shown in FIG. 8.

FIG. 10 is a partially side cross-sectional view of a stepladder in accordance with another preferred embodiment of the present invention.

FIG. 11 is a schematic operational view of the stepladder as shown in FIG. 10.

### DETAILED DESCRIPTION OF THE INVENTION

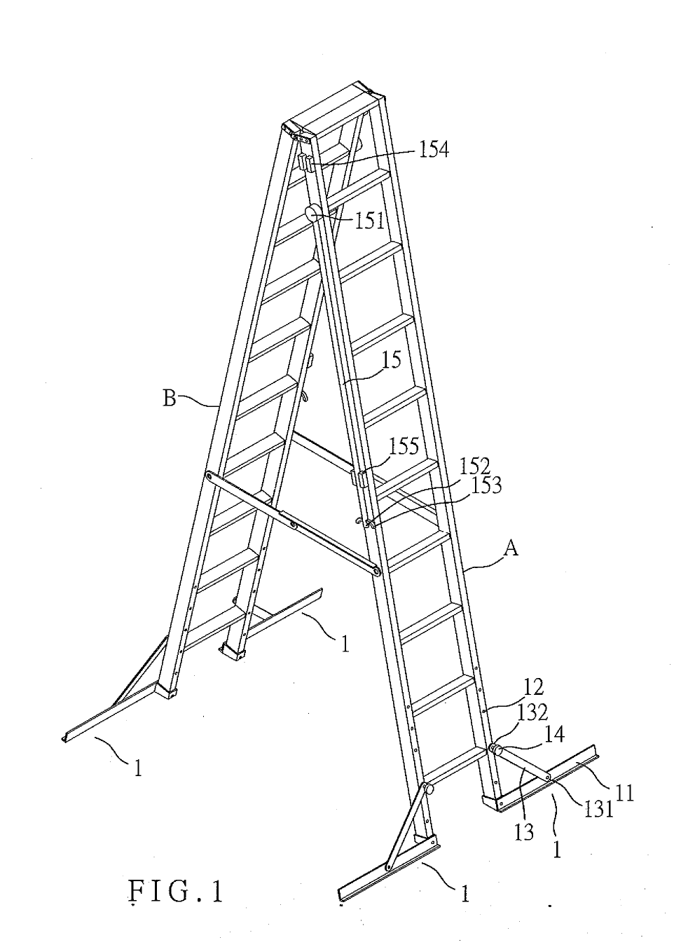

Referring to the drawings and initially to FIGS. 1-3, a stepladder in accordance with the preferred embodiment of the present invention comprises two frames “A” and “B” pivotally connected with each other, two pairs of support levers 11 pivotally connected with the two frames “A” and “B”, two pairs of links 13 pivotally connected with the two frames “A” and “B” and pivotally connected with the support levers 11, and two pairs of positioning members 14 connected with the links 13.

Each of the two frames “A” and “B” is formed with a plurality of fixing holes 12 which are equally distant from each other. Each of the two frames “A” and “B” is provided with a side bar 15 which has a first end formed with a connecting portion 151 and a second end formed with a working portion 152. The working portion 152 of the side bar 15 is provided with a hook 153. Each of the two frames “A” and “B” is provided with an upper retaining seat 154 for holding the side bar 15 and a lower retaining seat 155 for holding the side bar 15.

Each of the support levers 11 has a substantially L-shaped profile and is located at a lower end of each of the two frames “A” and “B”.

Each of the links 13 has a first end 131 pivotally connected with a mediate portion of each of the support levers 11.

Each of the positioning members 14 extends through a second end 132 of each of the links 13 and is positioned in one of the fixing holes 12 of each of the two frames “A” and “B”, so that each of the links 13 is connected with each of the two frames “A” and “B”.

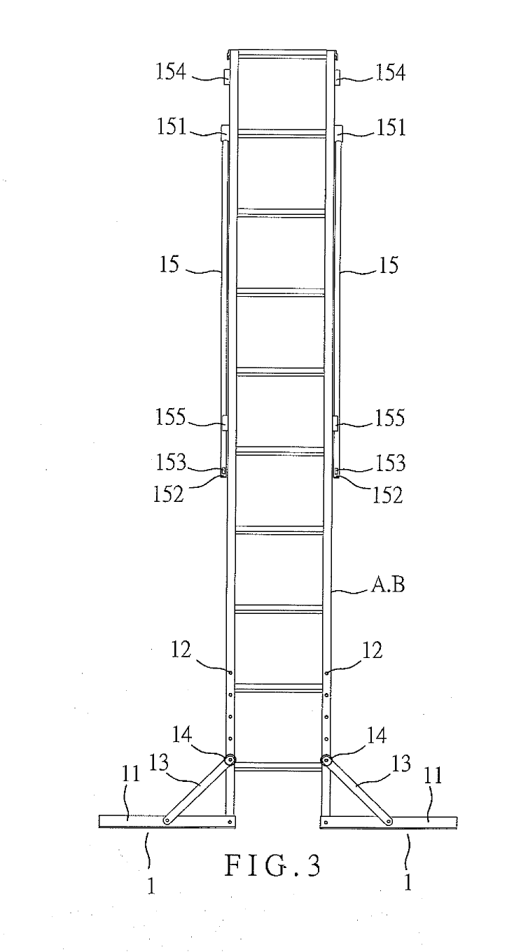

As shown in FIGS. 1 and 3, when the two frames “A” and “B” are expanded outward to form a substantially A-shaped structure, each of the support levers 11 is pivoted outward and downward to abut the ground, and each of the links 13 is connected between each of the support levers 11 and each of the two frames “A” and “B” in an inclined manner. Thus, each of the support levers 11 and each of the links 13 construct a tipping prevention device 1 to enhance solidity and stability of the stepladder and to prevent the stepladder from tipping or falling down, thereby protecting the worker's safety.

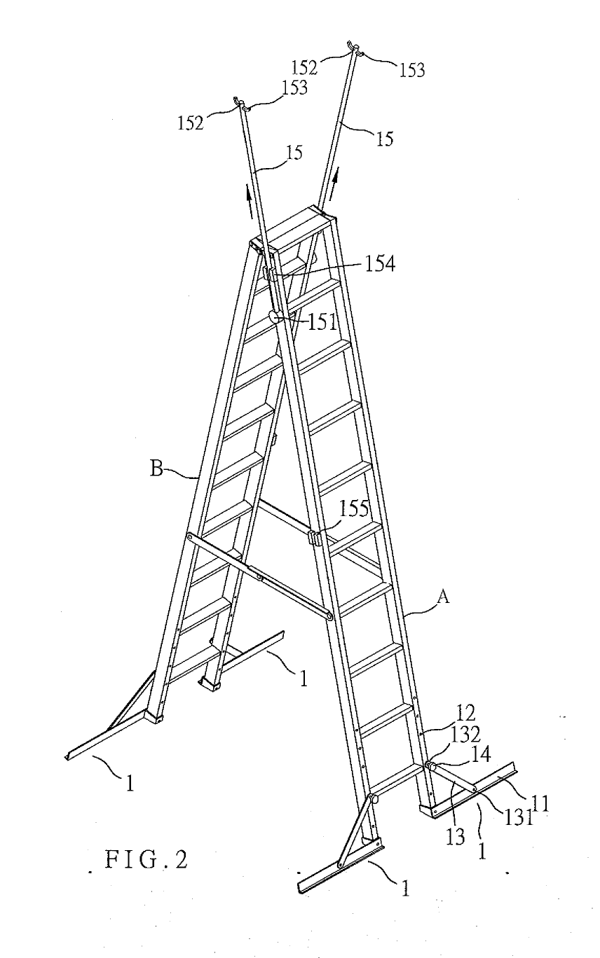

As shown in FIG. 2, when the side bar 15 protrudes upward from each of the two frames “A” and “B”, the side bar 15 is positioned by the upper retaining seat 154.

As shown in FIG. 1, when the side bar 15 is folded on each of the two frames “A” and “B”, the side bar 15 is positioned by the lower retaining seat 155.

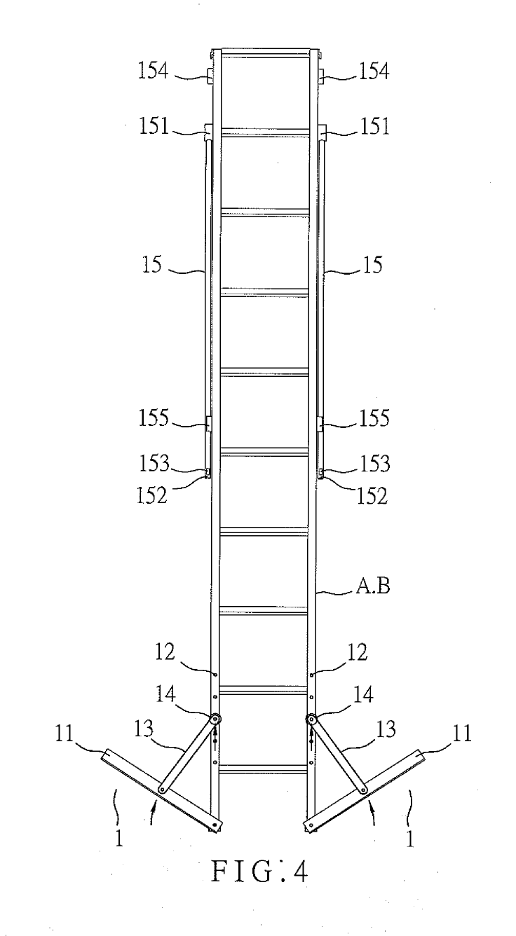

As shown in FIG. 4, each of the positioning members 14 is adjustably positioned in one of the fixing holes 12 of each of the two frames “A” and “B” to adjust the angle between each of the support levers 11 and each of the two frames “A” and “B”, so that the stepladder is placed on a slope zone solidly and stably, thereby protecting the worker's safety.

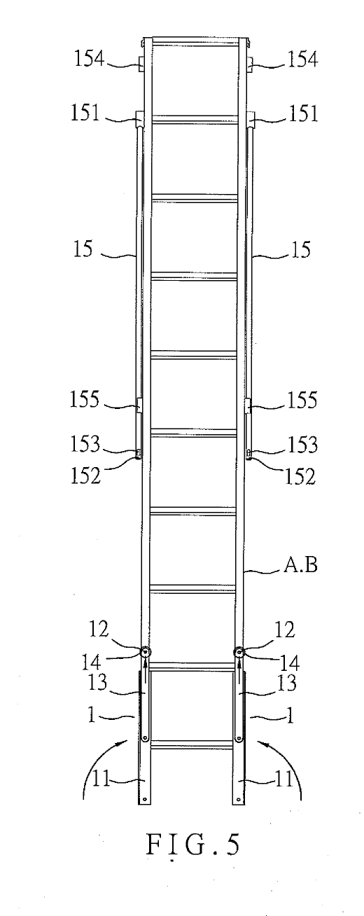

As shown in FIG. 5, each of the support levers 11 and each of the links 13 are folded on each of the two frames “A” and “B”.

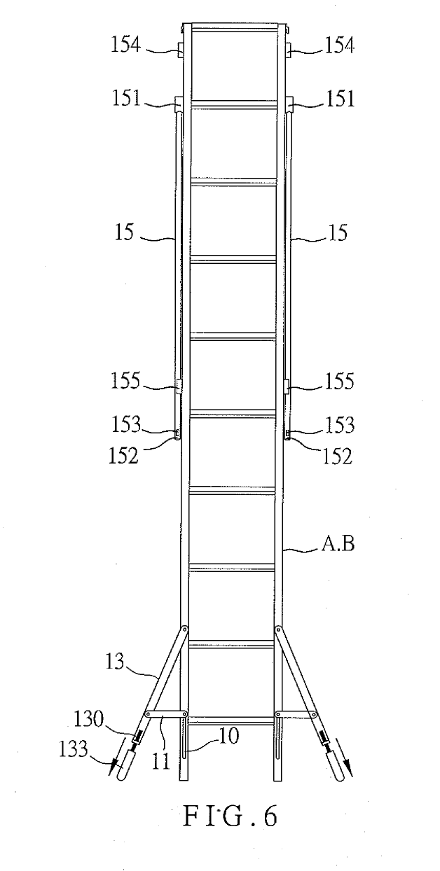

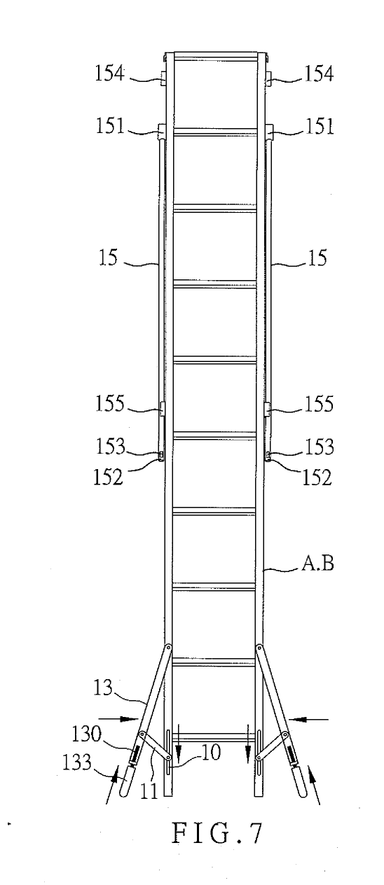

Referring to FIGS. 6 and 7, each of the support levers 11 is pivotally connected between each of the two frames “A” and “B” and each of the links 13. Each of the two frames “A” and “B” is formed with two elongate slots 10. Each of the support levers 11 has a first end pivotally connected with each of the links 13 and a second end pivotally and movably mounted in one of the two elongate slots 10 of each of the two frames “A” and “B”. Each of the links 13 has an upper end pivotally connected with each of the two frames “A” and “B” and a lower end provided with a threaded rod 130 which is connected with a threaded stand 133. In folding of each of the links 13, the threaded stand 133 is rotated and moved relative to the threaded rod 130 to shorten the distance between the threaded stand 133 and each of the links 13. Then, the second end of each of the support levers 11 is moved downward in one of the two elongate slots 10 of each of the two frames “A” and “B” as shown in FIG. 7, so that each of the links 13 is pivoted and moved toward each of the two frames “A” and “B” until each of the links 13 is folded on each of the two frames “A” and “B”.

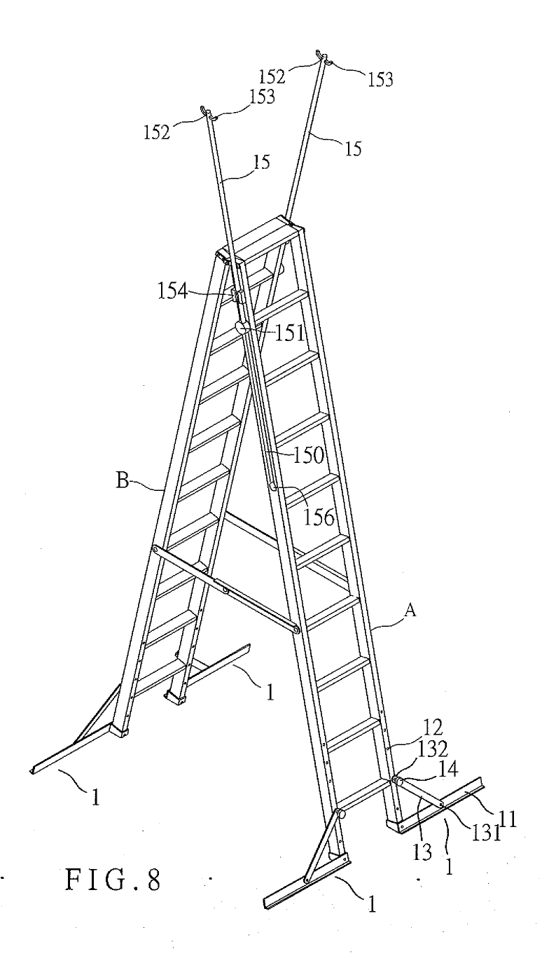

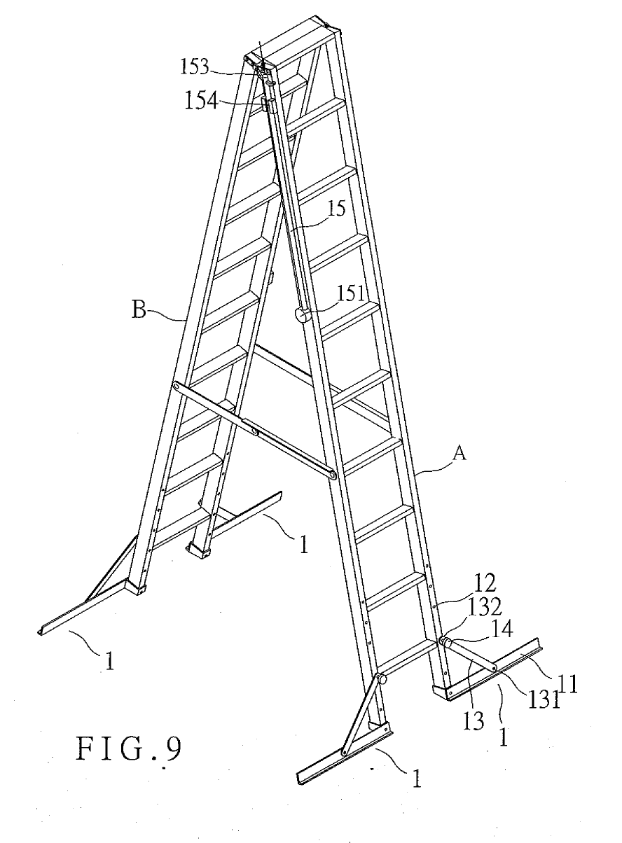

Referring to FIGS. 8 and 9, each of the two frames “A” and “B” is formed with a slideway 150 to allow a sliding motion of the connecting portion 151 of the side bar 15. The slideway 150 of each of the two frames “A” and “B” has two ends each formed with a limit hole 156 to limit the connecting portion 151 of the side bar 15. Thus, the working portion 152 of the side bar 15 is constantly directed upward and protrudes outward from the top of the stepladder.

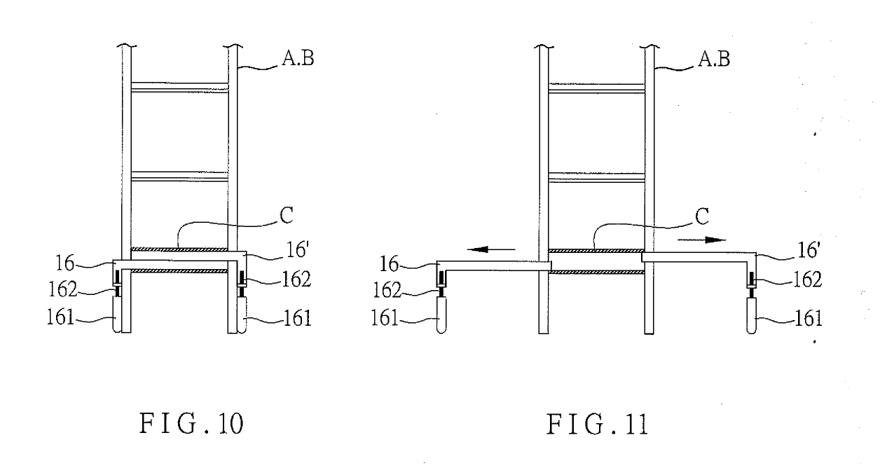

Referring to FIGS. 10 and 11, each of the two frames “A” and “B” is provided with at least one foot board “C” which has an interior provided with two extension brackets 16 and 16′. Each of the extension brackets 16 and 16′ has a substantially L-shaped structure and has a transverse section extending into the interior of the foot board “C” of each of the two frames “A” and “B” and an upright section provided with a threaded rod 162 which is connected with a threaded leg 161. Thus, when the transverse section of each of the extension brackets 16 and 16′ is retracted into the interior of the foot board “C” of each of the two frames “A” and “B”, the upright section of each of the extension brackets 16 and 16′ and the threaded leg 161 are moved to abut each of the two frames “A” and “B” as shown in FIG. 10, and when the transverse section of each of the extension brackets 16 and 16′ is expanded outward from the foot board “C” of each of the two frames “A” and “B”, the upright section of each of the extension brackets 16 and 16′ and the threaded leg 161 are moved outward to space from each of the two frames “A” and “B” as shown in FIG. 11 so as to provide a support function to each of the two frames “A” and “B”.

Accordingly, each of the support levers 11 is expanded and placed on the ground, and each of the links 13 is connected between each of the support levers 11 and each of the two frames “A” and “B” in an inclined manner, so that the two frames “A” and “B” are supported solidly and stably so as to enhance solidity and stability of the stepladder and to prevent the stepladder from tipping or falling down, thereby protecting the user's safety. In addition, the side bar 15 is expanded to protrude upward from each of the two frames “A” and “B”, so that the user can hold the side bar 15 when standing on the two frames “A” and “B”, thereby enhancing the user's safety. Further, the side bar 15 is provided with a hook 153 to hang the user's tool bag when the user stands highly on the two frames “A” and “B”.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A stepladder comprising:
two frames pivotally connected with each other;
two pairs of support levers pivotally connected with the two frames; and
two pairs of links pivotally connected with the two frames and pivotally connected with the support levers.

2. The stepladder of claim 1, wherein:
the stepladder further comprises two pairs of positioning members connected with the links;
each of the two frames is formed with a plurality of fixing holes;
each of the links has a first end pivotally connected with a mediate portion of each of the support levers; and
each of the positioning members extends through a second end of each of the links and is positioned in one of the fixing holes of each of the two frames, so that each of the links is connected with each of the two frames.

3. The stepladder of claim 1, wherein each of the two frames is provided with a side bar which has a first end formed with a connecting portion and a second end formed with a working portion.

4. The stepladder of claim 3, wherein the working portion of the side bar is provided with a hook.

5. The stepladder of claim 3, wherein each of the two frames is provided with an upper retaining seat for holding the side bar and a lower retaining seat for holding the side bar.

6. The stepladder of claim 1, wherein:
each of the support levers is pivotally connected between each of the two frames and each of the links;
each of the two frames is formed with two elongate slots;
each of the support levers has a first end pivotally connected with each of the links and a second end pivotally and movably mounted in one of the two elongate slots of each of the two frames; and
each of the links has an upper end pivotally connected with each of the two frames and a lower end provided with a threaded rod which is connected with a threaded stand.

7. The stepladder of claim 1, wherein:
each of the two frames is formed with a slideway to allow a sliding motion of the connecting portion of the side bar;
the slideway of each of the two frames has two ends each formed with a limit hole to limit the connecting portion of the side bar; and
the working portion of the side bar is constantly directed upward and protrudes outward from a top of the stepladder.

8. The stepladder of claim 1, wherein:
each of the two frames is provided with at least one foot board which has an interior provided with two extension brackets; and
each of the extension brackets has a substantially L-shaped structure and has a transverse section extending into the interior of the foot board of each of the two frames and an upright section provided with a threaded rod which is connected with a threaded leg.

9. The stepladder of claim 1, wherein each of the support levers has a substantially L-shaped profile and is located at a lower end of each of the two frames.
